(19) United States
(12) Patent Application Publication
(10) Pub. No.: US 2014/0185138 A1
(43) Pub. Date: Jul. 3, 2014

(54) PERISCOPE WITH WIDE-ANGLE VIEWING FIELD

(71) Applicants: Werner Sklarek, Heidesheim (DE); Hubertus Russert, Heidenrod (DE); Juergen Boer, Bischofsheim (DE)

(72) Inventors: Werner Sklarek, Heidesheim (DE); Hubertus Russert, Heidenrod (DE); Juergen Boer, Bischofsheim (DE)

(73) Assignee: SCHOTT AG, Mainz (DE)

(21) Appl. No.: 14/113,881

(22) PCT Filed: May 4, 2012
(86) PCT No.: PCT/EP12/01922

§ 371 Date: Jan. 15, 2014

Related U.S. Application Data
(60) Provisional application No. 61/563,891, filed on Nov. 28, 2011.

(30) Foreign Application Priority Data
May 4, 2011 (DE) 10 2011 100 494.0

(51) Int. Cl. G02B 23/00

(52) U.S. Cl. CPC G02B 23/00
USPC 359/403; 359/402

(57) ABSTRACT

A periscope that provides a wide-angle viewing field while having a compact physical size is provided. The periscope has at least two objective lenses with their optical axes at an angle to each other so that the objective lenses image different solid angle regions.

The invention generally relates to periscopes. More particularly, the invention relates to periscopes for armored systems, such as in particular armored vehicles.

Periscopes are well known from prior art, also for armored vehicles. They are used, inter alia, to transmit image information to a protected space. A periscope of usual configuration comprises an angled mirror assembly including two mirrors obliquely inclined relative to the observation direction, which deflect the incident light two times to direct it to the observer. Such angled mirror assemblies for armored vehicles are known from DE 20 2006 004 546 U1, and from WO 2010/066220 A1, for example.

A general problem with periscopes is their limited viewing field. To increase the viewing field, it is known to configure periscopes so as to be rotatable. For example, from WO 97/42 538 a periscope is known which has a periscope head that is freely rotatable about 360°. However, such solutions are mechanically complex. In addition, there is still the problem that in the viewing direction of the observer the viewing field is very limited. Therefore, the observer may only get a comprehensive overview of the environment when actually pivoting the periscope. However, already observed areas will fall out of sight upon pivoting.

In addition, the mechanism of pivotable periscopes does not permit them to be fitted into an existing, limited installation space. This impedes retrofitting of existing systems.

Furthermore, it is possible to transfer images to the observer via electronic cameras. While such systems can be configured to be very compact, a problem therewith is that the system is dependent on a voltage supply and so it is rather susceptible on the other hand.

Generally, a problem with current periscopes is that the armor of the vehicle is interrupted in the region of the periscope. Angled mirror assemblies require an opening in the armor which corresponds at least to the dimensions of the mirrors. This large area opening of the armor is a weak point in the protection of vehicle occupants. This even applies if direct penetration of a projectile into the interior is not possible due to the angled mirror assembly, since secondary fragments may result upon a hit of the periscope head, which will penetrate into the vehicle interior through the periscope.

Therefore, the invention is based on the object to improve the protection of the interior of an armored system, such as in particular an armored vehicle.

Accordingly, the invention provides a periscope comprising a periscope head which has a light entrance opening, and an observer side light exit end spaced apart from the periscope head, typically with a light exit opening and/or a viewing means such as an eyepiece, wherein an objective lens is arranged in the periscope head, and wherein an image light guide is provided, also referred to as a multi-fiber image guide below, which includes a multitude of light conducting fibers extending side by side, to transfer an image as generated by the objective lens from the periscope head to the light exit end, and wherein an armor plate is arranged between the periscope head and the light exit end, which armor plate has an opening through which the image light guide extends.

The armor plate prevents a projectile or secondary fragments resulting upon an impact of a projectile from penetrating into the interior of the armored system along the periscope. Instead of the large area opening of the angled mirror there is only an opening in the armor plate, through which the image light guide is passed. Here, even the image light guide itself has a high shielding effect. A projectile or a secondary fragment may be deflected by the image light guide at least to such an extent that it does not penetrate through the opening of the armor plate. This protective effect is especially promoted in case a rigid image light guide is used. In particular a rigid image light guide is considered, more preferably a rigid image light guide composed of glass fibers, who's protecting effect is particularly good due to the hardness of the material, inter alia. Moreover, a glass fiber image light guide is particularly suitable due to the insensitivity of the material under extreme conditions, in particular at high temperatures. For example, temperatures of up to 75° C. may arise at the armor and inside the periscope when used in deserts. In case of plastics, these temperatures may lead to a degradation over time.

The use of a glass fiber optic with a light entrance side objective lens brings yet another significant advantage. This arrangement prevents light from the interior of the protected system from escaping to the outside, or at least substantially reduces this amount of light as compared to a conventional angled mirror. That is because, on the one hand, the light guide generally passes fewer light backwards from the interior of the protected system to the light exit opening as compared to the angled mirror assembly, since the cross-sectional area of the image light guide is considerably smaller than the cross-sectional area of the optical path of an angled mirror assembly. On the other hand, the focal length of the upstream objective lens leads to a widening of the angle of the exiting light beam. This further significantly reduces the light intensity for a remote observer. Therefore, a protected system having light sources in the interior and a periscope according to the invention will be more difficultly located visually in the dark by a distant observer as compared to a system equipped with a conventional angled mirror assembly.

The risk of a full penetration and/or passage of secondary fragments resulting from an impact of a projectile may be further reduced by the following measures: A shielding plate is arranged offset or spaced from the armor plate in a direction of light transfer of the image light guide, the shielding plate also having an opening through which the image light guide extends. The opening in the shielding plate is offset relative to the opening in the armor plate as seen in the viewing direction along the periscope. In other words, the opening in the shielding plate and the opening in the armor plate are offset in a direction transverse to the longitudinal direction of the periscope, or in case of an arrangement in which one side of the armor plate faces the periscope head, offset along that side of the armor plate. Preferably, the shielding plate is spaced apart from the armor plate in a longitudinal direction of the periscope towards the light exit end.

In particular, the shielding plate itself may constitute an armor plate but will be referred to as a shielding plate, because its wall thickness may be chosen to be smaller than the wall thickness of the armor plate, i.e. because the shielding plate may be thinner than the armor plate in order to reduce weight. The shielding plate can be dimensioned to be thinner since the kinetic energy of a projectile or secondary fragment will already be significantly reduced in the armor plate, so that the shielding plate will be subjected to lower dynamic impact loads even if the projectile or a secondary fragment should penetrate the armor plate.

Another measure which permits to enhance the protection against a penetration of a secondary fragment, especially in conjunction with the armor plate, surprisingly consists in weakening the armor of the periscope. Namely, according to one embodiment of the invention, the periscope head has a rear wall portion opposite the light entrance opening for an objective lens, which wall portion is thinner than the wall of lateral wall portions of the periscope head, or even has an opening. In fact, the light entrance opening is a weakening of the armor. Now, according to this embodiment of the invention, a weakened or even missing armor is also provided at the opposite side of the periscope head. If a projectile penetrates through the light entrance opening, it may exit through the rear weakened or missing armor without that the impact momentum of the projectile is completely absorbed and without generating highly energetic fragments or deflecting the projectile in the longitudinal direction of the periscope. In this case, only the optical components would be damaged or destroyed. If glass components are employed, very small fragments with a correspondingly low momentum will typically result, which cannot penetrate through the armor plate.

According to another aspect, a further object of the invention is to provide a periscope system which provides a wide-angle viewing field while having a compact physical size.

To achieve this object of providing a wide-angle viewing field given a compact physical size, the invention provides a periscope system or a periscope which has at least two objective lenses that have their optical axes at an angle to each other so that the lenses will image different solid angle regions. That is, the optical axes of two objective lenses span a plane. If more than two image guides and objective lenses are provided, all optical axes may advantageously lie in one plane. Generally, it will be beneficial to arrange the objective lenses in a manner so that this plane is horizontal, so that the individual objective lenses capture a solid angle region that includes the horizon line. However, it is not compulsory with more than two objective lenses, that optical axes thereof all lie in one plane. While such an arrangement is favorable, especially if the horizontal line is intended to be approximately in the center of the image, other arrangements are also possible. For example, the optical axis may also lie on an imaginary conical surface.

At least two multi-fiber image guides are provided which are also referred to as image light guides below, a respective one of the multi-fiber image guides being associated with a respective objective lens. Each first, objective lens side end of a multi-fiber image guide is arranged with respect to the associated objective lens in a manner so that the image produced by the objective lens is projected onto the first, objective lens side end of the multi-fiber image guide. At least one longitudinal portion of the multi-fiber image guide extends transverse to the optical axis of the associated objective lens. To permit the image guide to transfer the image produced at the first end, a first light redirecting means or image deflector is provided to redirect the light from the direction of the optical axis of the objective lens to the longitudinal direction of the longitudinal portion of the multi-fiber image guide.

The multi-fiber image guides have second, observer side ends that are arranged side by side so that the partial images visible at these ends, as projected by the objective lenses onto the first ends and transferred to the second ends, will give a composite image of the total solid angle region projected onto the first ends by the objective lenses. In particular, the observer side optical system which in the simplest case only consists of the ends of the image guides, may be configured in a manner so that the panoramic image is fully visible to an observer.

The invention has specific advantages over conventional periscopes or angled mirror assemblies. An objective lens of the periscope increases the divergence of the light in particular when the objective lens captures a wide-angle region. If, as in a conventional periscope, the light is directed to an observer along a free beam path zone downstream the first redirecting mirror or prism, a large portion of the light will not be incident on the eyepiece due to the divergence of the light. According to the inventive arrangement, by contrast, the light is transferred by total reflection in the individual fibers of the image guides. Despite of the divergence the light rays will reach the second end of the image guides in this way, and thus will reach the observer. This results in a very high light intensity of the periscope system of the invention.

When compared to camera systems, on the other hand, the invention offers the advantage to operate merely optically, at least up to the image output at the second ends of the image guides. This ensures a high level of reliability. Moreover, damage to one of the image channels formed by the image guides and associated objective lens will not lead to a total failure of the system, but only to a restriction of the viewing field.

According to a further embodiment of the invention, a second light redirecting means is provided, which redirects the light exiting from the second, observer side ends of the multi-fiber image guides back to the direction of the optical axis of the respective objective lens associated therewith. In this way a viewing direction is produced for an observer which corresponds to the objective lens side viewing direction or viewing plane, or at least approximates it. This redirecting need not necessarily completely or exactly undo the redirecting of the first redirecting means. Rather, the viewing angle may be adapted to the respective application or to the desired observing position.

A multi-fiber image guide in accordance with the invention refers to an image guide or image light guide that comprises a multitude of optical fibers or light conducting fibers in which the arrangement of the optical fibers at the ends thereof correspond to one another so that an image projected onto one end will be visible at the other end. The orientation of the image at the light exit end may optionally be different from the orientation of the image at the light entrance side end. In particular, a rotation of the output end image may be achieved by a twist in the multi-fiber image guide. This is particularly advantageous in one embodiment of the invention, as will be explained below.

If a flat or substantially flat panoramic image of the total solid angle region captured by the objective lenses is to be achieved at the observer side, the angle between the optical axes of the objective lenses or the viewing directions of the individual objective lenses will result in a rotation of the orientation of the individual partial images due to the redirecting by the first redirecting means. In order to allow, on the observer side, to assemble the partial images with the same orientation, a twist may be introduced into at least one of the multi-fiber image guides such that the orientation of an image transferred to the second end is at an angle to the orientation of the image produced on the first end. In particular, the twist may be such that the orientation of the image transferred to the second end corresponds to the orientation of the image of an adjacent multi-fiber image guide transferred to the second end. This orientation may for example be the direction of the vertical.

Furthermore, it is advantageous for the image quality to produce a rather seamless picture at the observer side from the partial images transferred by the individual multi-fiber image guides. To this end, it is first of all useful to align the objective lenses in a manner so that the solid angle regions captured by the objective lenses overlap each other. Here, the solid angle region captured refers to the entire region captured by the objective lens, but not necessarily to the region projected onto the cross-sectional area of the first end of the image guide or the region transferred to the second end of the image guide. In order that the partial images can be joined seamlessly to one another at the second ends of the multi-fiber image guides, it is favorable to choose the cross-sectional shapes of the second ends of the image guides such that the cross-sectional areas of adjacent ends of the image guides contact each other at mating abutting edges. Preferably, the image guides are in particular arranged in a manner so that a transferred partial image is continued by the partial image of an adjacent image guide across the abutting edge with correct orientation and without any offset. For ease of manufacturing, rectilinear abutting edges are particularly suitable for this purpose.

For this purpose it is possible to use image guides having at least one planar lateral face. For example, image guides having a rectangular or square cross-sectional shape may be used. However, such image guides are more difficult to manufacture. Another, simple way is to treat an image guide of a predetermined shape on the second end thereof to form a planar lateral face, in particular by grinding. According to one embodiment of the invention, image guides having a circular cross section are used for this purpose, for example, which are chamfered at their lateral surface at a second end thereof, wherein the inclined surface introduced thereby forms a rectilinear edge at the second end.

In order to obtain a very large total solid angle region with the periscope arrangement of the present invention, objective lenses are preferably used which have a field viewing angle of at least 45°, more preferably of at least 55°.

Furthermore, a sufficient image resolution should be achieved in order to limit a loss of image information due to the screening of the image caused by the individual fibers. To this end, according to another embodiment of the invention, each of the multi-fiber image guides comprises at least 50,000, preferably at least 100,000 light conducting fibers. With more than 100,000 optical fibers, a spatial resolution of better than 30 cm can be achieved at a distance of 100 meters even when using wide-angle lenses capturing a field viewing angle of more than 50° and projecting it to the end of the image guide.

Since due to the use of image guides the structural design is very compact and is in particular customizable depending on the application due to an adaptable shaping of the image guides, the invention is particularly suitable for replacing an existing angled mirror assembly in an installation duct of a protected vehicle, in particular an armored vehicle. Especially in armored vehicles the space requirements are particularly critical, since the installation duct for an angled mirror is an opening and thus a weak point in the armor and therefore is preferably kept as narrow as possible. The invention may also be used as a monitoring device in radiation-protected vehicles or in observer rooms.

The invention will now be described in more detail by way of exemplary embodiments and with reference to the accompanying drawings. The same reference numerals refer to the same or to corresponding elements. In the drawings:

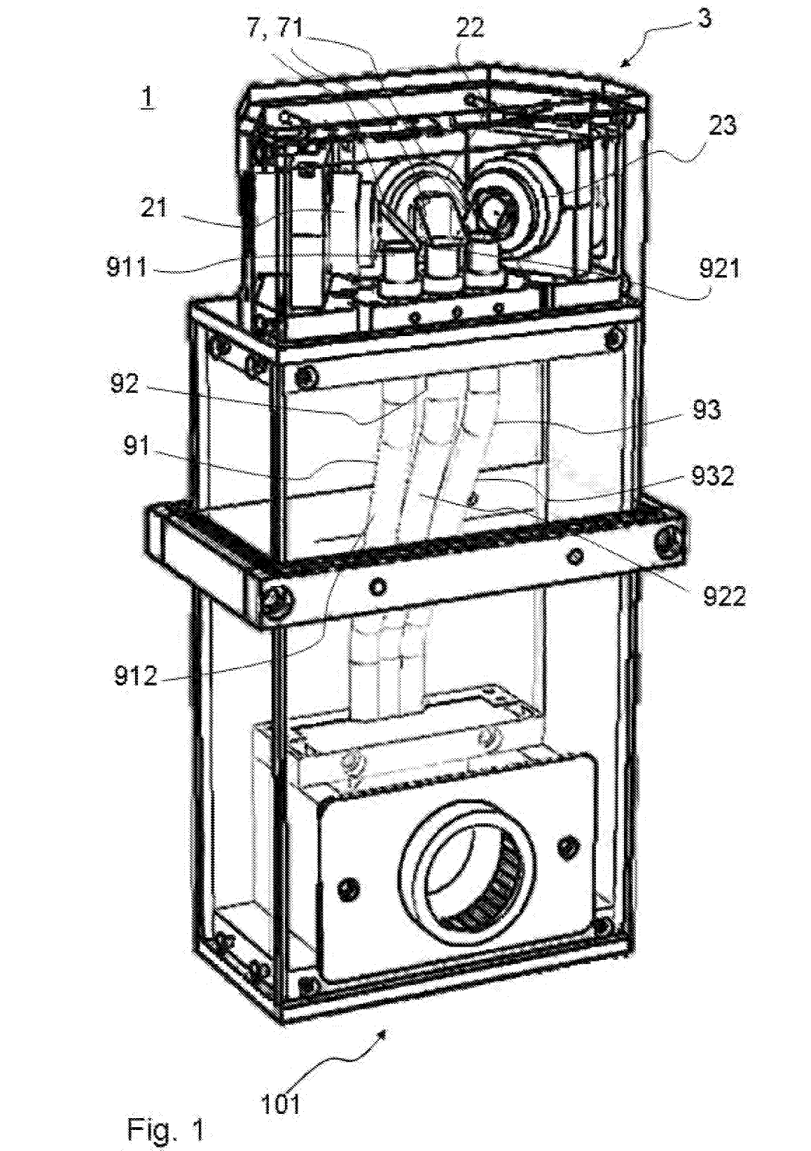

FIG. 1 is a view of a periscope system;

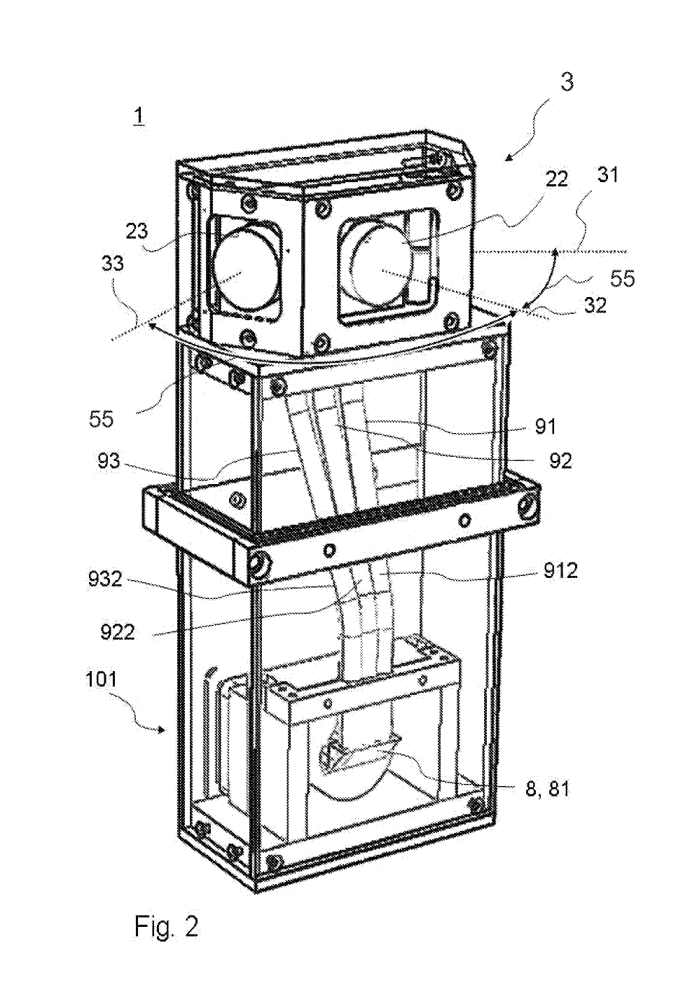

FIG. 2 is a view of the periscope system as seen from the opposite side;

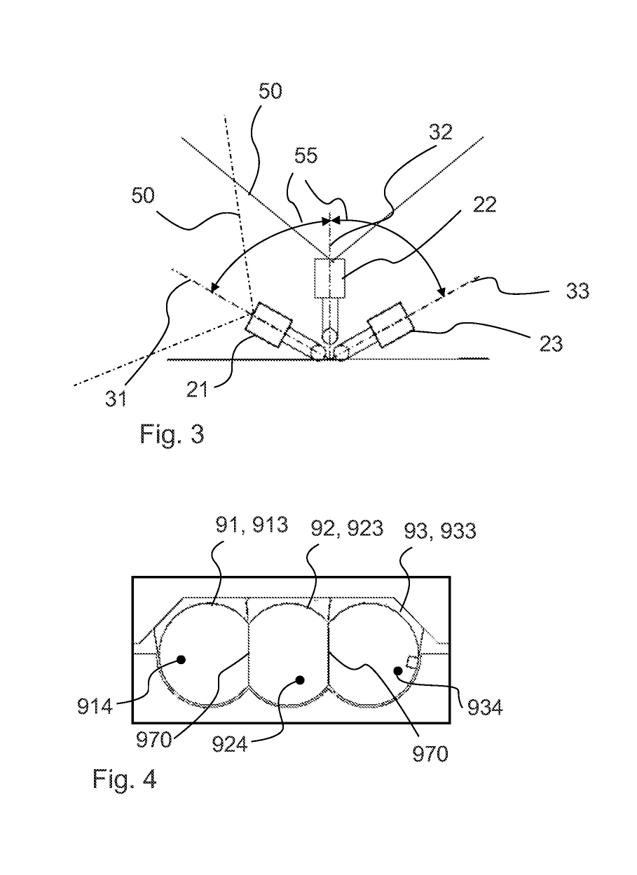

FIG. 3 is a schematic plan view of the arrangement of objective lenses;

FIG. 4 is a plan view of the second, light exit side ends of the multi-fiber image guides;

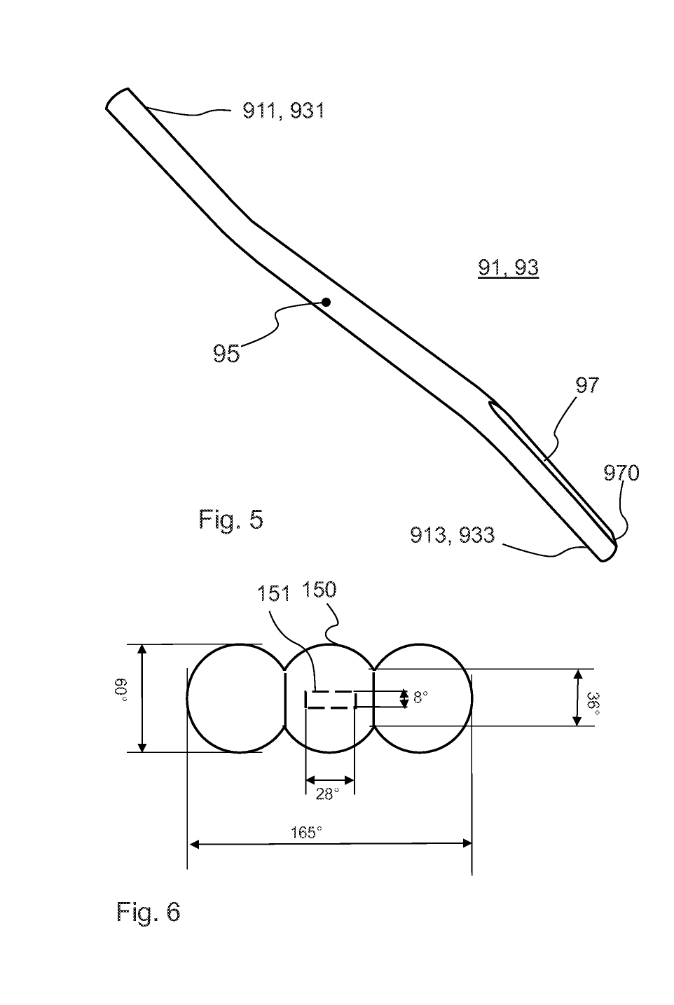

FIG. 5 is a view of a multi-fiber image guide;

FIG. 6 illustrates the viewing field of the periscope system;

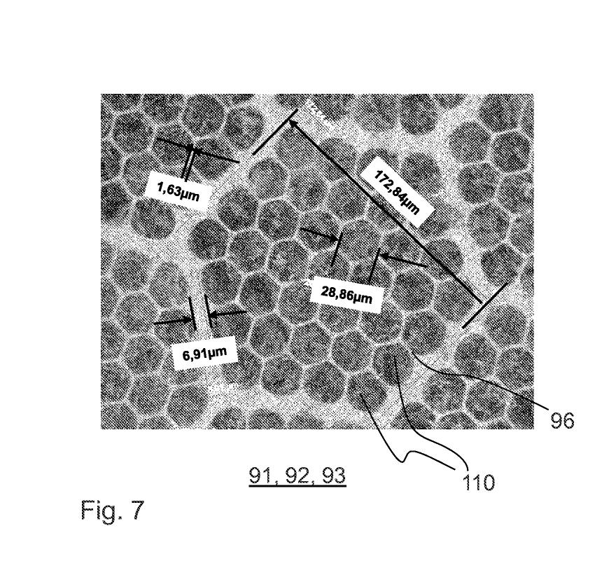

FIG. 7 shows a cross-sectional micrograph of a multi-fiber image guide;

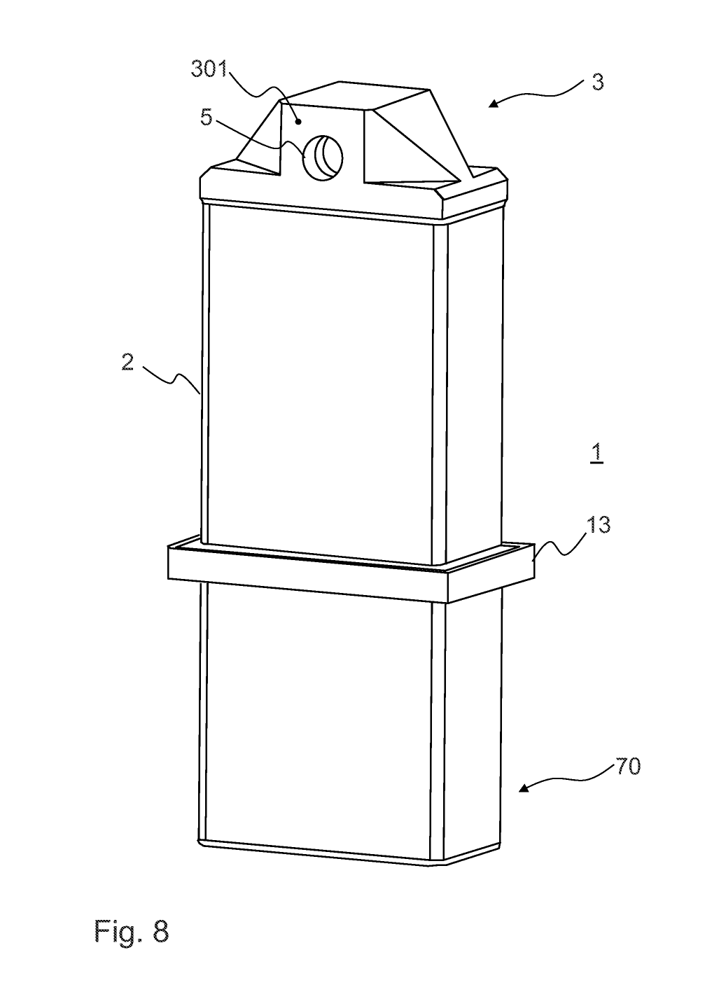

FIG. 8 is a front view of another embodiment of a periscope;

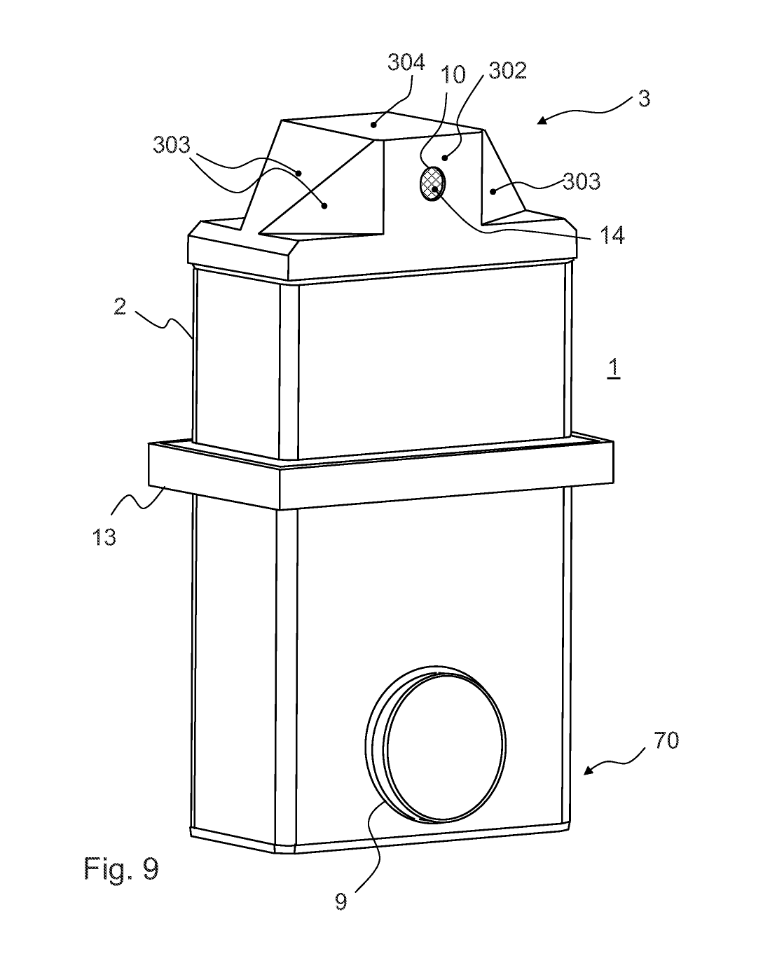

FIG. 9 is a rear view of a periscope;

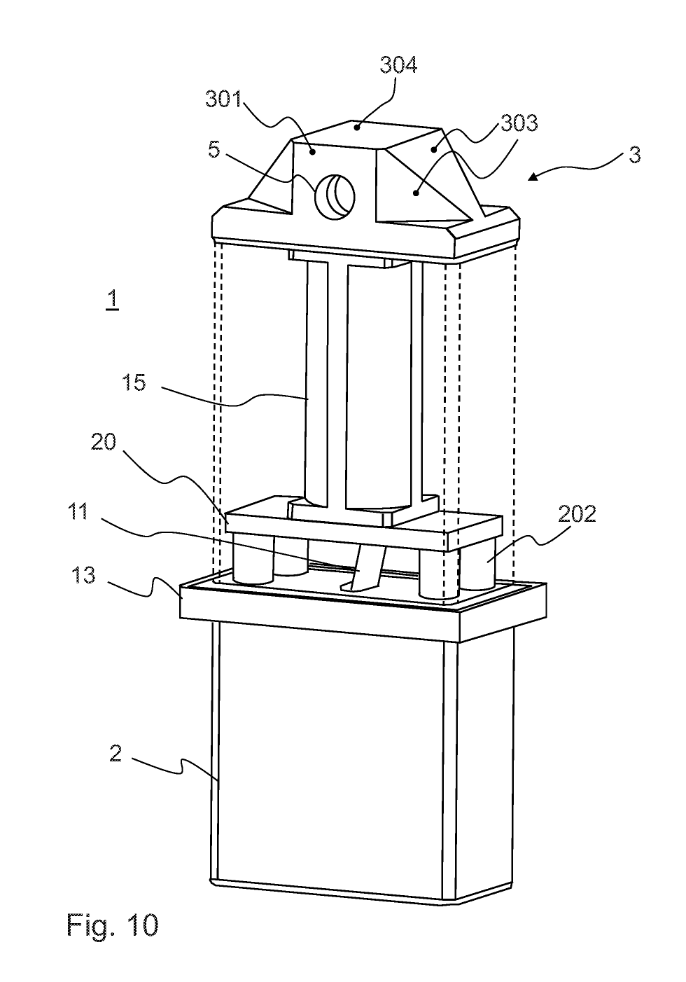

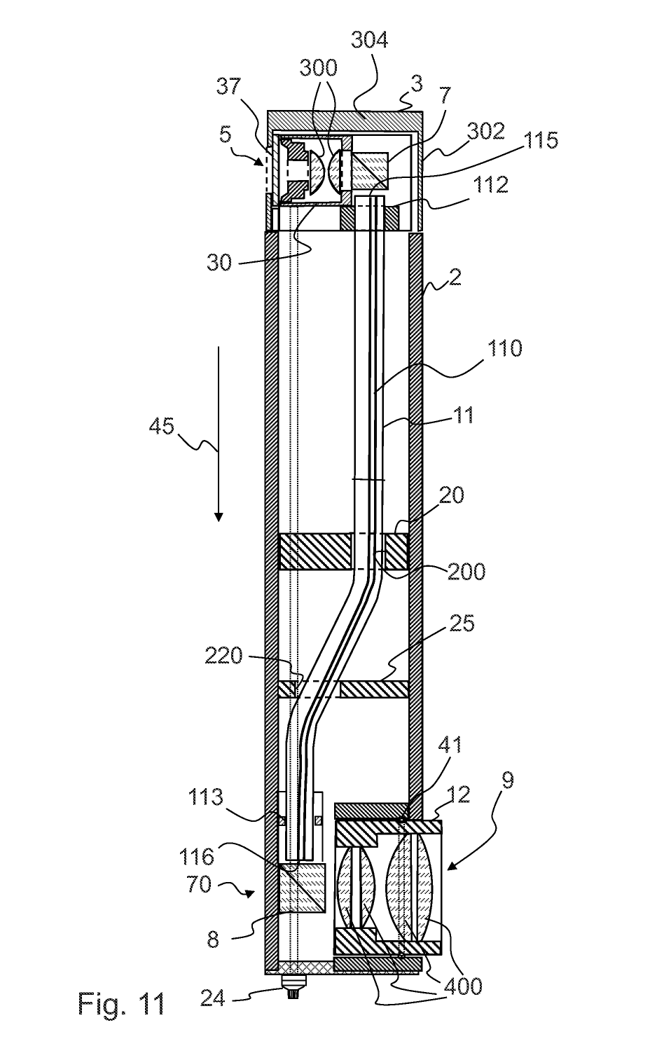

FIG. 10 is a partially sectional view of the periscope shown in FIG. 8; and

FIG. 11 is a sectional side view of a periscope.

FIGS. 1 and 2 show two views of a periscope system 1 according to the invention. FIG. 1 shows the periscope system 1 from the side of the eyepiece 12, and FIG. 2 is a view of the opposite side where three objective lenses 21, 22, 23 are arranged in this embodiment. Objective lenses 21, 22, 23 are facing different directions, so that there is an angle 55 between the optical axes 31, 32, 33 of the objective lenses or the viewing directions thereof. In the view of FIG. 2, only two of the objective lenses 22, 23 can be seen, and the optical axis 31 of objective lens 21 and its angle 55 with the optical axis 32 of the adjacent objective lens 22 are indicated. In the example shown in FIG. 1 and FIG. 2, the viewing directions of objective lenses 21, 22, 23 or the optical axes 31, 32, 33 thereof are in one plane. Appropriately, the periscope system 1 is in particular installed such that this plane is horizontal or substantially horizontal, in order to see the terrestrial environment in a wide angular range.

In addition thereto, FIG. 3 shows a schematic plan view of the arrangement of objective lenses 21, 22, 23 having optical axes 31, 32, 33, and with angles 55 between the optical axes of adjacent objective lenses. Additionally, the cones of solid angle regions 50 captured by the objective lenses are indicated for objective lenses 21, 22. The cones intersect at some distance from the objective lenses. Accordingly, the solid angle regions 50 captured by the objective lenses overlap each other. Without being limited to the exemplary embodiments described herein, each of the objective lenses preferably captures a solid angle with an opening angle or field viewing angle of at least 45°, more preferably at least 55°. Wide-angle lenses as provided according to the invention additionally have the advantage that very fast objective lenses can be used. All the more so, as the spatial resolution is anyway limited by the fiber diameter of the individual optical fibers or light conducting fibers of the image guides. Therefore, objective lenses can be used in which the light intensity is optimized in favor of spatial resolution. Therefore, without being limited to the exemplary embodiments illustrated, preferred objective lenses have an aperture ratio 1/x with x<2, preferably with x<1.4.

The periscope system 1 of the invention further comprises at least two multi-fiber image guides, in correspondence to the number of objective lenses provided, so accordingly the embodiment shown in FIG. 1 and FIG. 2 comprises three multi-fiber image guides 91, 92, 93. Each multi-fiber image guide 91, 92, 93 is associated with a respective one of objective lenses 21, 22, 23 and transfers its image information from periscope head 3 to an observation means 101 at the opposite end of the periscope system 1. For this purpose, at least one longitudinal portion 912, 922, 932 of each multi-fiber image guide 91, 92, 93 is arranged transverse to the optical axis of the associated objective lens 21, 22, 23.

FIG. 1 shows objective lenses 21, 22, 23 from the rear side or light exit side. The light exiting from objective lenses 21, 22, 23 is redirected towards the first, objective lens side ends 911, 921, 931 of multi-fiber image guides 91, 92, 93 by a first light redirecting means 7, also referred to as an image deflector below. In the illustrated embodiment, first light redirecting means 7 comprises prisms 71 disposed at the rear side of objective lenses 21, 22, 23. By means of this light redirecting means 7, the image produced by objective lens 21, 22, 23 is then deflected onto the first, objective lens side end 911, 921, 931 of the multi-fiber image guide 91, 92, 93 and is projected thereupon.

In the embodiment shown in FIG. 1 and FIG. 2, multi-fiber image guides 91, 92, 93 extend transversely, in particular substantially perpendicular to optical axes 31, 32, 33, not only along a longitudinal portion 912, 922, 932 thereof but along their complete longitudinal extension. However, it is also possible to provide a curved portion of the multi-fiber image light guide as a light redirecting means 7, so that the image light guide merges from a first portion extending in the direction of the optical axis of the objective lens into a longitudinal portion extending transversely thereto.

As can be seen from FIG. 2, a second image deflector or second light redirecting means 8 is provided, which again deflects the light exiting from the second, observer side ends 913, 923, 933 of multi-fiber image guides 91, 92, 93. In correspondence to a conventional periscope, the light is in particular again redirected towards the observing direction of the periscope, i.e. to the direction of optical axes 31, 32, 33 of the respective associated objective lens 21, 22, 23. In the illustrated exemplary embodiment, a shared prism 81 is used as a redirecting means 8, which deflects the light of all multi-fiber image guides 91, 92, 93 merged at their second, observer side ends 913, 923, 933. Here, an eyepiece 12 is used as an observation means 101 which permits to view, via the prism, the magnified partial images of the imaged solid angle region visible at the second ends 913, 923, 933 of image guides 91, 92, 93. Without limitation to the particular exemplary embodiment illustrated in the figures, the eyepiece 12 may comprise one lens, a plurality of lenses, or a Fresnel lens or stepped lens, in order to magnify the panorama image visible at second ends 913, 923, 933.

In terms of image impression and detectability of the environment it is particularly favorable for the observer if an overall picture as seamlessly as possible is produced from the partial images visible at the observer side ends 913, 923, 933. For this purpose, the cross-sectional faces 914, 924, 934 of the second ends 913, 923, 933 of multi-fiber image guides 91, 92, 93 are arranged with mating abutting edges 970 adjacent to each other, with the image guides arranged in such a manner that a transferred partial image is continued by the partial image of an adjacent multi-fiber image guide (91, 92, 93) across the abutting edge with correct orientation and without any offset.

One such embodiment is shown in FIG. 4 which is a plan view of the cross-sectional faces 914, 924, 934 of the second, light exit side ends 913, 923, 933 of multi-fiber image guides 91, 92, 93.

As can be seen from FIG. 4, multi-fiber image guides 91, 92, 93 have a round, preferably cylindrical shape. Such image guides are easier to manufacture than image guides of a square or rectangular cross section. Furthermore, a round cross-sectional shape is well adapted to the imaging of the objective lenses, so that a very good utilization of the viewing field provided by lenses 21, 22, 23 is achieved. On the other hand, there is the problem that round cross-sectional faces cannot be fitted adjacently to contact one another seamlessly along a line, but will only contact each other at a point. To solve this problem, multi-fiber image guides 91, 92, 93 are chamfered at their lateral surfaces 95 at the second, light exit end 913, 923, 933 to form an inclined surface 97, the introduced inclined surface forming a rectilinear edge 970 at the second end 913, 923, 933. These rectilinear edges 970 will then define the abutting edges at which the multi-fiber image guides are fitted against each other.

FIG. 5 shows a multi-fiber image guide treated accordingly, in particular by way of example one of the two outer multi-fiber image guides 91, 93 having an inclined surface 97 at the second end 913, or 933. Instead of an inclined surface, the entire lateral surface could be ground off on one side in order to obtain a rectilinear edge at the second end of the multi-fiber image guide, which is somewhat more complex however.

FIG. 6 shows a viewing field 150 as it can be achieved with the arrangement according to the preceding figures. The shape of viewing field 150 corresponds to the shape of cross-sectional faces 914, 924, 934 of multi-fiber image guides 91, 92, 93 as fitted together. Preferably, the multi-fiber image guides 91, 92, 93 are arranged in a manner so that the partial images are fitted to one another in the horizontal direction.

Here, the smallest visible range in the vertical direction will be produced along the abutting edges. However, as can be seen from the exemplary embodiment of FIG. 6, the captured angular range there is still 36°. In the central region of the partial images the maximum value in this direction is reached, corresponding to the field viewing angle projected onto the first end of the respective multi-fiber image guide. This viewing angle imaged by the objective lenses onto the first ends 911, 921, 931 is about 60° in the example shown in FIG. 6. In this way, a field viewing angle of slightly more than 165° is obtained in the horizontal direction, or more generally in the direction along which the partial images are fitted to one another. Thus, almost the entire half-space is imaged in this direction and is presented to the observer as a flat panoramic image well detectable at a single glance.

Without being limited to the exemplary embodiments shown and described herein, the field viewing angle of the image at the second ends of the multi-fiber image guides along the direction in which at least two, preferably at least three partial images are combined, is at least 120°, preferably at least 150°.

For comparison, a typical viewing field 151 of a conventional angled mirror is shown, as it is frequently used in armored vehicles. In this case, the viewing angle in the horizontal direction is only 28°, and is even only 8° in the vertical direction. It will be apparent herefrom that the arrangement according to the invention, though not being limited to the angles particularly specified, provides for a significantly improved all-around visibility as compared to a conventional angled mirror, or even provides such all-around visibility at first, without that the arrangement needs to be moved. In armored vehicles the available space is usually so narrow that a rotation of the entire arrangement is not possible or not intended. Here, in contrast to an angled mirror and with the same space requirements the invention thus provides the possibility to simultaneously capture a very wide angular range of the environment. In the exemplary embodiment illustrated, the viewing field obtained by the invention is increased as compared to the viewing field of a conventional angled mirror by about a factor of 30, that is by about 3000%.

A particular advantage of the invention, as can also be seen from the example of FIG. 6, is an increase of the vertical viewing angle. Generally, without limitation to the exemplary embodiment illustrated, the vertical viewing angle may be increased from typically about 8° of a conventional angled mirror to a viewing angle of preferably at least 35°. When considering the viewing angles in the center of the partial images, this increase is even much greater. When installed in a vehicle, this results in a significantly lower dependency on the inclination of the vehicle or terrain. With the vertical viewing angle of 8° as conventionally achieved, even a slight slope of the ground may already cause that critical regions of the environment, particularly in the region of the horizon, or more generally of the wider environment of the vehicle are no longer observable.

The invention furthermore provides for an improved armor, or more generally an improved shielding of the protected observer space. With a conventional angled mirror, the armor has to be opened in similar dimensions as that of the mirror. With a periscope system according to the invention, a passageway for the multi-fiber image guides may be sufficient. For this purpose, a shielding or armoring intermediate plate may be arranged in a horizontal central plane. More generally, the periscope system may comprise a shielding or armor between the first and second ends of the multi-fiber image guides, through which the multi-fiber image guides extend.

The invention may in particular also be implemented with a periscope having a single objective lens and a single image light guide or multi-fiber image guide instead of the at least two multi-fiber image guides and at least two associated objective lenses, as will be explained in more detail further below with reference to the exemplary embodiments of FIGS. 8 to 11. If the armor plate is employed in a periscope system having at least two objective lenses according to the invention, it will be advantageous if each of the multi-fiber image guides extends through the armor plate. In this case, according to a first embodiment of the invention separate openings may be provided, with a single multi-fiber image guide extending through a respective one of the openings. According to a variation, a common opening may be provided, through which at least two multi-fiber image guides are passed.

FIG. 7 shows a cross-sectional micrograph of a multi-fiber image guide 91, 92, 93 that can be used for the invention. The multi-fiber image guide is composed of a multitude of individual optical fibers or light conducting fibers 110, the optical fibers 110 being surrounded by a cladding 96 having a refractive index greater than the refractive index of the light conducting material of the optical fibers 110 or the core thereof. Accordingly, the light is transferred in the individual optical fibers 110 by total reflection. Several dimensions of the multi-fiber image guide as used for the invention are indicated in FIG. 7 by way of example. The optical fibers 110 are arranged in a hexagonally packed pattern. In the example shown in FIG. 7, the width of optical fibers 110 between two opposed side surfaces is 28.86 μm. The shared cladding 96 between two adjacent light conductors 110 has a thickness of 1.63 μm. As can further be seen, the individual optical fibers 110 are combined to form hexagonally shaped strands with a width of about 172 μm. The spacing of edge side optical fibers 110 of two strands herein is 6.91 μm.

For producing multi-fiber image guides as shown in FIG. 7 by way of example, the method described in German patent application DE 10 2010 052 479.4 is particularly suitable. Therefore, this method for producing the multi-fiber image guides is fully incorporated into the subject-matter of the present application.

The method is based on bundling parallel light conducting rods of equal length, wherein the cross-sectional area and the number of light conducting rods are selected in relation to the cross-sectional area of a surrounding sheath. The bundled light conducting rods may be held together by a sheath or by an auxiliary device. The bundled light conducting rods are then subjected to a drawing process in which the light conducting rods are fused to one another by heat supply. A plurality of so produced fiber rods may then be combined and subjected to a further bundling and drawing process. In this manner, multi-fiber rods can be produced which can be used as multi-fiber image guides, the diameter of a single optical fiber 110 thereof being not greater than 100 μm, as is the case in the example shown in FIG. 7. In particular, the packing density of optical fibers 110 or the proportion of light conducting material in the cross-sectional area may be more than 98%, preferably at least 99%, and more preferably more than 99%.

While being re-heated, the multi-fiber image guides may then be bent into an appropriate shape, as is shown in FIG. 5 by way of example. At the same time a twist may be introduced, so that the orientation of the cross-sectional faces at the two ends is twisted relative to each other (ends 911, 913, and 931, 933 of the two outer multi-fiber image guides 91, 93 in the example shown in FIGS. 1 to 3). Such a twist will compensate for an image rotation which is caused by the deflection of light from the lateral viewing directions of outer objective lenses 21, 23 to the planar representation in observation means 101.

Besides the prisms shown in the figures, mirrors are also considered as light redirecting means. Instead, it is also possible to simply have the multi-fiber image guides bent accordingly, so that the light redirecting means are entirely or partially realized by curved portions of the image guides.

Furthermore, the viewing directions of the objective lenses do not need to lie in one plane. Also, unlike what is shown in the figures, a horizontal viewing angle of more than 180° may be readily realized. Since the multi-fiber image light guides can be bent and twisted in almost any way, a panoramic view of 360° viewing angle can be readily realized. In this case, it is also possible to display two or more partial images superposed in order to reduce the width of the panoramic image and to permit faster assessment of the information content thereof.

FIG. 8 is a front perspective view of a housing 2 of a periscope 1 according to the invention.

FIG. 9 is a rear side view of a corresponding periscope 1. The essentially only difference of the embodiment shown in FIG. 9 is that it is made shorter. Periscope 1 comprises a periscope head 3 having a light entrance opening 5, and spaced apart from the periscope head 3 in the longitudinal direction of the housing 2 a light exit end 70 at which an image of the surroundings is produced for an observer by the optical system of periscope 1. In this exemplary embodiment, an annular clamping belt 13 extends around housing 2. With the embodiment illustrated, for fastening the periscope 1 in a protected system, e.g. in particular an armored vehicle, periscope 1 may be inserted into a duct intended for an angled mirror assembly and may then be clamped at the clamping belt using brackets arranged at the wall of the protected system.

Therefore, an existing angled mirror assembly may be replaced by a periscope 1 of the invention, without being limited to the specific exemplary embodiment illustrated. Therefore, according to one embodiment of the invention, retrofitting of an armored system is also provided, the retrofitting comprising a replacement of an angled mirror assembly by a periscope according to the invention.

The periscope head 3 as a housing part has a plurality of wall elements. A light entrance opening 5 is provided in a front wall portion 301. As can also be seen from the exemplary embodiments of FIGS. 8 and 2, lateral wall portions 303 are inclined according to an embodiment of the invention. Specifically, lateral wall portions are provided with a surface inclined with respect to the longitudinal direction of housing 2, and thus also inclined to the image offset direction. The image offset direction refers to the direction along which the light entrance opening is spaced from an observation means at the light exit end 70. Mostly, periscopes are installed in a protected system in a manner so that the image offset is in vertical direction. Accordingly, in this case, lateral wall portions 303 will be arranged obliquely to the horizontal plane. The inclined arrangement of the lateral wall portions 303 has a bullet deviating effect on the one hand, and back reflections of radar and/or light rays will be reduced on the other, to reduce the visibility of the system equipped with the periscope of the invention for optical or radar detection devices.

If, as in the illustrated exemplary embodiments, the periscope 1 has a housing 2, a light exit opening 9 will be provided at the light exit end 70 of housing 2, at which the image as produced by the objective lens in the light entrance opening 5 is made visible for the observer by means of an observation means of the periscope 1. In the simplest case, the light exit end of the image light guide may serve as the observation means.

FIG. 10 shows an exemplary embodiment of a periscope 1 according to the invention in a partially sectional view towards light entrance opening 5. Specifically, the portion of the housing 2 between periscope head 3 and clamping belt 13 is shown cut away.

As can be seen from FIG. 10, an armor plate 20 is provided, through which image light guide 11 extends. Particularly suitable as a material for the armor plate 20 is a protective steel.

Between armor plate 20 and periscope head 3 a protective tube 15 is arranged, which encloses the image light guide 11. Protective tube 15 may have multiple functions. In particular, protective tube 15 is intended to shield the image light guide 11 in the head-side periscope portion against projectiles and secondary fragments. Though it would be possible to armor the housing 2 itself, however, this would lead to a significant weight increase due to the larger dimensions of housing 2, and hence to an increase in production costs without achieving any improvement in the shielding. Therefore, without being limited to the specific exemplary embodiment as shown in FIG. 10, a protective tube 15 is provided which extends at least along a portion between periscope head 3 and armor plate 20, wherein the protective tube 15 is disposed within a housing 2 of the periscope 1 and the image light guide 11 extends through the protective tube 15.

According to yet another embodiment, the protective tube 15 may be filled with a damping material. In this manner, the image light guide 11 in protective tube 15 may be mechanically stabilized laterally, for instance to dampen vibrations of the image light guide 11.

In the partly cut-away view of FIG. 10, image light guide 11 is only visible in a region below armor plate 20.

Furthermore, the protective tube may also be hermetically sealed, for example it may be hermetically joined to armor plate 20 and/or image light guide 11 in order to air-tightly seal optical components in the region between periscope head 3 and armor plate 20.

As can also be seen from the illustration of FIG. 10, armor plate 20 is secured offset from clamping belt 13 in the longitudinal direction or image offset direction of the periscope 1. In the specific exemplary embodiment illustrated, spacers 202 are used for this purpose, which spacers are mounted at the plane of clamping belt 13, and thereon, in turn, the armor plate 20 is attached. This arrangement serves the purpose that the means for fastening the periscope, which is specifically configured as a clamping ring 13 herein, is typically attached to an armor. The longitudinal offset of the armor plate 20 with respect to this fastening means will then ensure that upon insertion and mounting of the periscope in the periscope opening of the protected system, the armor plate 20 can be arranged in the plane of the armor of the protected system. It will be understood that the direction of the longitudinal offset of the armor plate 20, i.e. either an offset towards periscope head 3 as in the example shown, or towards the light exit end is selected depending on whether the periscope 1 is attached inside or outside the protected system. Typically, it will be secured inside. In this case, the armor plate 20 is advantageously offset from the fastening means towards the periscope head 3, so that when the periscope 1 has been installed the armor plate 20 is arranged in the plane of the armor of the protected system and closes the gap of the armor caused by the opening.

Therefore, without being limited to the particular exemplary embodiment illustrated in FIG. 10, in one embodiment of the invention a fastening means is provided at the periscope 1 for fastening the periscope 1 at the wall of a protected system or a protected space, and the armor plate 20 is offset with respect to the fastening means in the longitudinal direction of the periscope 1, or in the image offset direction.

FIG. 11 shows a sectional view of a periscope 1 according to the invention. It can be seen from FIG. 11 that an objective lens 30 is disposed in the periscope head 3 and looks through the light entrance opening 5. Objective lens 30 produces an image of the environment on the end face 115 of image light guide 11 which forms the light entrance face. This image is transferred, by the light conducting fibers of image light guide 11, to the end face 116 of image light guide 11 which serves as a light exit face. The image visible at light exit face 116 may then be observed by the user by means of an eyepiece 12 as an image observation means.

In the illustrated exemplary embodiment, image deflectors 7, 8 are arranged along the beam path, both upstream and downstream image light guide 11. Specifically, the light entrance side image deflector 7 is arranged between the light entrance face 115 of image light guide 11 and objective lens 30, and the light exit side image deflector 8 between light exit surface 116 and eyepiece 12. Preferably, image deflectors 7, 8 are configured as 90° deflectors.

As an alternative to using an image deflecting element, an appropriately bent image light guide 11 may be used. In this case, the curved portion of the image light guide functions to redirect the light at the light entrance side from the light incident direction to the image offset or longitudinal direction of periscope 1, and at the light exit side from the image offset direction of periscope 1 to the observation direction.

However, the use of one or two image deflectors is preferred, since bends of the image light guide with a small radius of curvature can be avoided in this way.

Generally, without being limited to the specific exemplary embodiment as shown in FIG. 11, at least one image deflector 7, 8 is therefore provided, for redirecting the incident light to an end face 115 forming a light entrance face of the image light guide 11, and/or for redirecting the light emitted from an end face 116 forming a light exit face.

Preferably, as is the case in the example of FIG. 11, the one or more image deflectors 7, 8 are implemented by prisms. Alternatively, however, mirrors can be used, for example.

Preferably, both the objective lens 30 and the eyepiece 12 each comprise a plurality of lenses 300, and 400, respectively.

In a preferred embodiment of the invention, the objective lens 30 is configured to be interchangeable. Thus, the objective lens 30 may be replaced quickly in the event of a defect. However, it is in particular also possible to provide several objective lenses 30 having different viewing angles and/or magnifications.

According to yet another embodiment of the invention, the objective lens 30 is configured as a zoom lens. This permits a user to adjust a viewing angle and/or magnification from inside the protected system, for example by means of an adjusting means 24 at the periscope 1. For convenience, such an adjusting means will preferably be provided in the region of the light exit end 70 of the periscope 1.

Even with an objective lens 30 having a fixed magnification such an adjusting means 24 may be provided for focusing the image. Generally, therefore, one embodiment of the invention provides an adjusting means 24 which enables a user to adjust the objective lens 30 during operation of the periscope 1, for readjusting the focus or setting a magnification.

In the light entrance opening of periscope head 3, a front glass 37 is disposed. This front glass serves to air-tightly seal the interior of the periscope head including the optical system. Thus, the interior of the periscope 1 or at least the region including the optical components may be filled with an inert gas such as dry nitrogen. This will prevent fogging of the components in case of large temperature changes or high humidity. The front glass may perform several tasks. It is also possible for this purpose to arrange multiple front glasses 37 consecutively. A particularly good mechanical protection is achieved by a sapphire glass, for example. Furthermore, a laser protection filters may additionally be provided in this or another place of the optical system of the periscope 1, especially for blocking infrared laser beams. Should the protected system be targeted using a laser and upon an impingement of the laser beam on the light entrance opening, such a filter will prevent the laser beam from exiting from the eyepiece which otherwise could be harmful for the user.

In conjunction with such a laser protection filter there are also advantages resulting from the configuration according to the invention as compared to a conventional angled mirror. With the inventive configuration, a laser protection filter can be kept relatively small. When placed in front of the objective lens, it need not be substantially larger than the light entrance opening. With an angled mirror, by contrast, the laser protection filter would need to have dimensions of the order of the much larger mirror. This advantage is also obtained with sapphire front glasses. Here, a front glass with dimensions similar to those of the mirror would have to be used with an angled mirror, which would greatly increase the cost of such an arrangement.

Thus, the use of image light guide 11 generally permits to employ small-sized optical components. This allows for either lower-cost production or the use of accordingly higher quality optical components.

Another measure for blocking infrared laser radiation is to use optical components with intrinsic absorption. Suitable for absorbing infrared radiation as is typically emitted from laser bearing devices are lead-containing glasses. In particular, the image light guide 11 itself may include light conducting lead-containing glass fibers.

Moreover, periscope 1 is especially distinguished from known angled mirrors by its improved protection against projectiles or secondary fragments, such as chips. Especially the armor plate 20 as described before contributes to this protection, which armor plate extends transversely to the direction of light offset or longitudinal direction 45 and only has a small opening 200 for passing the image light guide 11, as can be seen in the example of FIG. 11. Preferably, without limitation to the exemplary embodiment, the inside diameter of opening 200 is at most 20% larger than the corresponding transverse dimension of the image light guide. If the image light guide has a circular cross section and the opening 200 has a circular shape, the inner diameter of opening 200 will accordingly be not more than 20% larger than the outer diameter of image light guide 11.

Another effective measure of protection that can be provided in one embodiment of the invention is to provide a double wall armor. Such armor is particularly effective when the openings in the individual armor plates are offset relative to each other in a manner so that they do not or at least not completely overlap in the longitudinal direction of the periscope. This ensures that a projectile or fragment which penetrates in the longitudinal direction of the periscope through the opening of the first armor plate, will not additionally encounter the opening of the second armor plate, but is stopped by the second armor plate. In other words, in one embodiment of the invention, and as illustrated in FIG. 11 by way of example, a shielding plate 25 is provided, which is arranged offset from the armor plate 20 in the direction of light transmission of the image light guide 11, and the shielding plate also has an opening 220 through which the image light guide 11 extends, and the opening 220 in shielding plate 25 is offset with respect to the opening 200 in armor plate 20 as seen in the direction along the periscope 1, or in the longitudinal direction or image offset direction.

More preferably, the shielding plate 25 is offset from the armor plate 20 towards the light exit end 70, or expressed vice versa, the armor plate 20 is offset relative to the shielding plate 25 towards the periscope head 3.

The second armor plate is referred to as a shielding plate herein, since the thickness thereof may optionally be kept smaller than that of the armor plate 20. It can be seen that this is also the case in the example shown in FIG. 11. This is advantageous, because fragments or projectiles that still penetrate the armor plate 20 will already lose part of their momentum and/or will undergo fragmentation into several smaller fragments of a smaller momentum so that the momentum to be intercepted by the shielding plate 25 is lower. The reduced thickness is then favorable to reduce the weight of the periscope 1. Preferably, in this embodiment of the invention, the thickness of the shielding plate ranges from ⅛ to ¾ of the thickness of the armor plate 20.

Alternatively, it is also possible to provide a different material for the shielding plate in order to achieve a high shielding effect while reducing weight. For example, a material with a higher ductility as compared to the material of the armor plate 20 may be used for the shielding plate 25 to intercept the remaining momentum of penetrating parts. If a material other than that of the armor plate 20 is used for the shielding plate 25, the thickness of the shielding plate may, if necessary, be selected to be equal to or even greater than that of the armor plate 20.

As a further measure to improve the shielding in the longitudinal direction of the periscope, the upper wall portion 304 of the periscope head 3 may, alternatively or additionally, be configured so as to shield from projectiles and/or fragments. In particular, it is suggested to use a wall thickness and appropriate material which shield from projectiles and/or fragments, as for the lateral wall portions 303 visible in FIGS. 8 to 10. Surprisingly, however, the shielding effect and the safety for the user of the periscope may be significantly improved, if not the entire periscope head 3 is configured to shield from projectiles and/or fragments. In particular, it is suggested according to one embodiment of the invention to provide the rear wall portion 302 of the periscope head 3 opposite the light entrance opening 5 with a wall which is made thinner than the wall of lateral wall portions 303 and preferably also thinner than the upper wall portion 304 of the periscope head 3, or which has an opening.

This embodiment of the invention is clearly apparent from the illustration in FIG. 11. Rear wall portion 302 opposite light entrance opening 5 has a substantially smaller wall thickness than the upper wall portion 304. Specifically, in this exemplary embodiment, the wall thickness of the rear wall portion 302 is thinner by about a factor of four as compared to the upper wall portion 304.

This has the effect that a projectile or fragment impinging in the light entrance opening 5 may pass through the periscope head and exit from rear wall portion 302 without any substantial momentum transfer or deflection in the longitudinal direction towards the light exit end 70. This will therefore prevent both an unfavorable deflection of the projectile as well as a generation of high-energy secondary parts which could otherwise penetrate into the interior of the protected system along the periscope 1. When a high-energy part such as a projectile or a corresponding high-energy fragment impinges in the light entrance opening, notwithstanding that the optical components arranged in the periscope head 3 will usually be destroyed, the risk to the occupants of the protected system, however, will be greatly reduced.

If necessary, the destroyed optical components such as objective lens 30 and image deflector 7, or the entire periscope head 3 with associated optical components may be exchanged rapidly, and so the periscope 1 may quickly be made ready for operation again.

Such a configuration of the armor of the periscope head 3 with the advantages mentioned above may also be provided in the embodiments of the invention illustrated in FIGS. 1 and 2. Given a suitable angle between the objective lenses 21, 22, 23, the rear wall portion with the thinner or absent armor may even be kept quite small, because the optical axes of the objective lenses which roughly define the critical trajectories converge and cross each other. If the rear wall portion is closer to this crossover point than the entrance openings, a correspondingly smaller wall portion will suffice to allow an impinging projectile to pass through this wall portion and to exit. Therefore, according to one embodiment of the invention, the surface area of the rear wall portion with the thinner or absent armor is smaller than the total of the surface areas of the entrance openings.

Other than mentioned above, it is also possible that, advantageously, the entire chamber of the periscope 1 surrounding the inside optical components is sealed and filled with a dry gas such as dry nitrogen to avoid condensation on the optical surfaces. To this end, according to one embodiment of the invention, the light exit opening 9 at the eyepiece 12 is also sealed by a gasket, e.g. a sealing ring 41.

However, in particular when the optical components are completely or partially sealed, as mentioned above, there might be a strong pressure development in the gas volume within the periscope when hit by a projectile. The increased pressure in turn may destroy the optical components even in regions that are not directly exposed to the projectile impact. Also, in such an event, chips or fragments may be produced even at the observer side or in the protected space of the armored system, or parts of the periscope 1 may be ejected. For example, the eyepiece 12 or chips of the ocular lenses 400 may be ejected and might cause injury to operation personnel. To avoid strong pressure development, a vent or gas outlet opening 10 may be provided in the periscope 1 in order to at least partially reduce an excess pressure caused in the periscope 1 by projectile impact. Generally, without being limited to the specific exemplary embodiments illustrated, at least one gas outlet opening is provided on the periscope in order to relief an excess pressure caused inside the periscope by a projectile impact. Such a gas outlet opening 10 may be provided at the periscope head 3. In the exemplary embodiment shown in FIG. 9, this opening 10 is arranged in the rear wall portion 302. In order to achieve a gas-tight enclosure of the optical components notwithstanding opening 10, a membrane 14 may be provided as shown in the example. This membrane 14 is adapted to break in the event of dangerous excess pressure. Alternatively, a gas outlet opening 10 may be equipped with a pressure relief valve. Other positions for one or more gas outlet openings 10 are conceivable. For example, such a gas outlet opening 10 may also be provided at the protective tube 15 shown in FIG. 10.

According to yet another embodiment of the invention, the interior of the periscope may be heated, alternatively or additionally, in particular regions including optical components, using appropriate means. Accordingly, in one embodiment of the invention the periscope may include a heating means.

Preferably, a rigid image light guide 11 made of glass fibers is used. Such image light guides are distinguished, inter alia, by a good transmission. However, even such a rigid image light guide 11 is preferably not formed as a straight rod, but is bent at least in sections thereof, as in the arrangement shown in FIG. 11. This makes it possible to offset the ends of image light guide 11 towards respective opposite side faces of the housing and thereby to obtain more space for the other optical components. Moreover, a double ballistic shielding with armor plate 20 and shielding plate 25 is made possible in this manner, with openings 200, 220 that are offset transversely to the longitudinal direction of the periscope 1.

An image light guide 11 is generally composed of a multitude of light conducting fibers 110, of which two fibers 110 are illustrated in FIG. 11 by way of example, the fibers 110 terminating at the end faces 115, 116 of image light guide 11. In order to transfer an image from one end face to the other, light conducting fibers 110 are arranged regularly to one another at both end faces 115, 116. Thus, each of fibers 110 provides one pixel of a transferred image. In a rigid image light guide, in particular a rigid image light guide 11 made of glass, the individual fibers 110 are joined to each other along the length of the image light guide 11 and run in parallel to each other.

If, as is preferred, a rigid image light guide 11 is used, in particular one made of glass, mechanical stresses may occur when retaining the image light guide 11 at the ends thereof due to different thermal expansion coefficients of the materials upon temperature changes, such stresses acting on the image light guide 11 in the longitudinal direction thereof. To avoid this, in one embodiment of the invention without being limited to the specific embodiment of FIG. 11, the image light guide 11 is retained at one of its ends using a locating bearing 112 and at the other end using a floating bearing 113. Locating bearing 112 fixes the image light guide 11 both in the radial and in the axial direction, while floating bearing 113 only effects a fixation in the radial direction or a lateral support.

The use of an objective lens 30 in conjunction with an image light guide 11 allows for a good ballistic shielding on the one hand, as already mentioned above, and the other hand prevents light from the interior of a protected system equipped with the periscope 1 from escaping to the outside. These advantages will be particularly significant when, as is the case with the exemplary embodiments shown, the image light guide 11 has a substantially smaller cross section than the periscope 1 and on the other hand an objective lens 30 with a short focal length is used. The short focal length leads to a small-area image and therefore in turn allows for a small image guide cross section. It is therefore preferable that the focal length of objective lens 30 is not more than 2 cm. The diameter of image light guide 11 is preferably less than 60 mm. Important for the effectiveness of the shielding and the prevention of light escape is furthermore the ratio of the cross-sectional area of image light guide 11 to the cross-sectional area of the periscope 1 as seen in the longitudinal direction. The smaller this ratio, the smaller can be kept the opening in the armor plate in relation to the cross-sectional area of the periscope. Preferably, the ratio of the cross-sectional area of image light guide 11 to the cross-sectional area of periscope 1 as seen in the longitudinal direction is not more than 1/30.

These parameters with the corresponding advantages may even be used with a periscope system having a plurality of multi-fiber image guides, as shown in FIGS. 1 and 2 by way of example. The above ratio of the cross-sectional areas of not more than 1/30 may apply to each individual multi-fiber image guide. However, it is also possible that the entire cross-sectional area of all the multi-fiber image guides is at most 1/30 of the cross-sectional area of periscope 1.

It will be apparent to those skilled in the art that the invention is not limited to the exemplary embodiments illustrated in the figures, but may be varied within the scope of the subject matter of the appended claims. The features of the individual exemplary embodiment may in particular be combined or replaced by alternatives mentioned in the above description. For example, image deflectors 7, 8 do not constitute compulsory components and may be replaced by a suitable bend of image light guide 11, inter alia. Furthermore, instead of a rigid image light guide 11 a flexible image light guide may be used, in which the light conducting fibers 110 are not rigidly joined between end faces 115, 116.

Also, the embodiments of FIGS. 8 to 11 may be extended in correspondence to the embodiments of FIGS. 1 to 6 in that the image field is segmented, i.e. that a plurality of image light guides or multi-fiber image guides are used, and that a total image of the image segments transferred by the multi-fiber image guides is assembled at the observer side. Advantages resulting therefrom include a higher overall brightness due to the use of a plurality of objective lenses associated with the individual image light guides. Furthermore, simple adjustment of the viewing field to the physiological field of vision is possible. To this end, the aspect ratio is between 2:1 and 4:1, as in the embodiments of FIGS. 1 to 6. Such an aspect ratio is also realized in the exemplary embodiment shown in FIG. 4.

Furthermore, generally in all embodiments comprising a plurality of image light guides, a magnification may be readily realized at the observer side, due to the larger original image. As mentioned before, the reliability of the system is, inter alia, enhanced by the fact that in the event of a hit by a projectile or a secondary fragment not all objective lenses will be destroyed, so that at least partial operation with a restricted viewing field will be possible. This reliability may especially be improved by providing a mechanical separation with additional ballistic protection between the individual optical paths.

It will be apparent to those skilled in the art that the embodiments of the invention are not limited to the exemplary embodiments as described above and illustrated in the figures, but may be varied within the scope of the appended claims. The features of individual exemplary embodiment may be combined. For example, a periscope system according to the present invention may also be realized with two, but also with four or more objective lenses and correspondingly the same number of multi-fiber image guides.

### LIST OF REFERENCE NUMERALS

1 Periscope
2 Housing
3 Periscope head
5 Light entrance opening
7 First light redirecting means
8 Second light redirecting means
9 Light exit opening
10 Gas outlet opening
12 Eyepiece
13 Clamping belt
14 Membrane
15 Protective tube
20 Armor plate
21, 22, 23, 30 Objective lenses
24 Adjusting means
25 Shielding plate
31, 32, 33 Optical axes of 21, 22, 23
37 Front glass
41 Sealing ring
45 Image offset direction
50 Solid angle region
55 Angle between 31, 32, 33
70 Light exit end
71, 81 Prism
11, 91, 92, 93 Multi-fiber image guides
95 Lateral surfaces of 91, 92, 93
96 Lateral surface of 110
97 Inclined surface
101 Observation means
110 Light conducting fibers, optical fibers
112 Locating bearing for 11
113 Floating bearing for 11
115 End face, light entrance face of 11
116 End face, light exit face of 11
150 Viewing field
151 Viewing field of angled mirror
200 Opening in 20
202 Spacer
220 Opening in 22
300 Objective lens
301 Front wall portion of 3
302 Rear wall portion of 3
303 Lateral wall portion of 3
304 Upper wall portion of 3
400 Ocular lens
911, 921, 931 First, objective lens side end of 91, 92, 93
912, 922, 932 Longitudinal portion of 91, 92, 93
913, 923, 933 Second, observer side end of 91, 92, 93
914, 924, 934 Cross-sectional areas of second ends 913, 923, 933
970 Rectilinear edge

1-22. (canceled)

23. A periscope comprising:
a periscope head which has a light entrance opening;
an observer side light exit end spaced apart from the periscope head;
at least one objective lens arranged in the periscope head;
a multi-fiber image guide comprising a plurality of light conducting fibers extending side by side to transfer an image generated by the at least one objective lens from the periscope head to the light exit end; and
an armor plate arranged between the periscope head and the light exit end, the armor plate having an opening through which the multi-fiber image guide extends.

24. The periscope as claimed in claim 23, further comprising a shielding plate offset with respect to the armor plate in a direction of light transfer of the multi-fiber image guide, wherein the shielding plate has an opening through which the multi-fiber image guide extends, and wherein the opening in the shielding plate is offset relative to the opening in the armor plate as seen in a viewing direction along the periscope.

25. The periscope as claimed in claim 23, further comprising a protective tube that extends along a portion between the periscope head and the armor plate, wherein the protective tube is arranged within a housing of the periscope, and wherein the image light guide extends through the protective tube.

26. The periscope as claimed in claim 23, wherein the at least one objective lens comprises at least one hermetically encapsulated objective lens.

27. The periscope as claimed in claim 23, further comprising a fastener connectable to a wall of a protected system, and wherein the armor plate is offset with respect to the fastener in a longitudinal direction of the periscope.

28. The periscope as claimed in claim 23, wherein the periscope head has a rear wall portion opposite the light entrance opening, the rear wall portion having a wall thickness smaller than that of a lateral wall portion of the periscope head.

29. The periscope as claimed in claim 23, wherein the periscope exhibits feature selected from the group consisting of a focal length of one objective lens that is not more than 2 cm, a diameter of the multi-fiber image guide that is less than 60 mm, a ratio of a cross-sectional area of the multi-fiber image guide to a cross-sectional area of the periscope as seen in a longitudinal direction that is not more than 1/30, and combinations thereof.

30. The periscope as claimed in claim 23, wherein the multi-fiber image guide comprises rigid glass fibers.

31. The periscope as claimed in claim 23, wherein the at least one objective lens is a zoom objective lens.

32. The periscope as claimed in claim 23, further comprising a laser protection filter that blocks infrared laser beams.

33. The periscope as claimed in claim 23, further comprising an adjuster that adjusts the objective lens in order to adjusted image sharpness or to adjust magnification.

34. The periscope as claimed in claim 23, wherein the at least one objective lens comprises at least two objective lenses whose optical axes are at an angle relative to each other so that the objective lenses image different solid angle regions,
wherein the multi-fiber image guide comprises at least two multi-fiber image guides, each multi-fiber image guide having a first end side being associated with a respective one of the objective lenses,
wherein each first side end is arranged relative to the associated objective lens so that the image formed by the objective lens is projected onto the first side end of the multi-fiber image guide, and
wherein at least one longitudinal portion of the multi-fiber image guides extends transverse to the optical axis of the associated objective lens.

35. The periscope as claimed in claim 34, further comprising a first light redirector that redirects the light from the direction of the optical axis of the objective lens to a longitudinal direction of the longitudinal portion of the multi-fiber image guide,
wherein each of the multi-fiber image guides has a second end that are arranged in side by side in a manner so that the partial images visible at the second side ends, as projected by the objective lenses onto the first side ends and transferred to the second side ends, give a composite image of the whole solid angle region imaged by the objective lenses onto the first side ends.

36. The periscope as claimed in claim 35, further comprising a second light redirector that redirects the light exiting from the second side ends again to the direction of the optical axis of the respective associated objective lens.

37. The periscope as claimed in claim 34, wherein at least one of the multi-fiber image guides has a twist so that an orientation of an image transferred to a second end of the multi-fiber image guide is at an angle to the orientation of the image projected to the first side end, wherein the twist is such that the orientation of the image transferred to the second side end coincides with the orientation of an image transferred to the second side end of an adjacent multi-fiber image guide.

38. The periscope as claimed in claim 23, wherein the at least one objective lens comprises at least two objective lenses that image different solid angle regions, the at least two objective lenses being aligned in a manner so that the solid angle regions imaged by the at least two objective lenses overlap.

39. The periscope as claimed in claim 34, wherein the second side ends of the multi-fiber image guides are arranged with mating abutting edges adjacent to each other, and wherein the multi-fiber image guides are arranged in a manner so that a transferred partial image is continued by the partial image of an adjacent multi-fiber image guide across the abutting edge with correct orientation and without any offset.

40. The periscope as claimed in claim 34, wherein the multi-fiber image guides are chamfered at lateral surfaces of the second side ends to form an inclined surface, wherein the inclined surface forms a rectilinear edge at the second side end.

41. The periscope as claimed in claim 23, wherein the at least one objective lens comprises a plurality of objective lenses each having a viewing angle of at least 45°.

42. The periscope as claimed in claim 23, wherein the at least one objective lens comprises a plurality of objective lenses each having a viewing angle of at least 55°.

43. The periscope as claimed in claim 23, wherein the multi-fiber image guide comprises a plurality of multi-fiber image guides each having at least 50,000 light conducting fibers.

44. The periscope as claimed in claim 23, further comprising a gas outlet opening for at least partially reducing an excess internal pressure caused by impact of a bullet.

45. A protected vehicle comprising the periscope as claimed in claim 23.

46. A method of using a periscope comprising replacing an angled mirror assembly in an installation duct of a protected vehicle with the periscope as claimed in claim 23.
